(19) United States
(12) Patent Application Publication
(10) Pub. No.: US 2018/0187865 A1
(43) Pub. Date: Jul. 5, 2018

(54) Lamp

(71) Applicant: OSRAM OLED GmbH, Regensburg (DE)

(72) Inventors: Thomas Wehlus, Lappersdorf (DE); Arne Fleissner, Regensburg (DE)

(21) Appl. No.: 15/739,634

(22) PCT Filed: Jun. 3, 2016
(86) PCT No.: PCT/EP2016/062693

§ 371 Date: Dec. 22, 2017

(30) Foreign Application Priority Data
Jun. 25, 2015 (DE) 10 2015 110 242.0

(51) Int. Cl. F21V 14/04; F21V 7/16; F21S 41/155; F21S 41/14; F21S 41/162

(52) U.S. Cl. CPC F21V 14/04; F21V 7/16; F21Y 2113/20; F21S 41/18; F21S 41/162; F21S 41/155

(57) ABSTRACT

A lamp is disclosed. In an embodiment, the lamp includes a first light source and a second light source embodied as a light-emitting reflector, with a reflective layer and an electroluminescent layer sequence. The second light source is deformable such that an emission pattern of light emitted by the first light source and reflected by the light-emitting reflector is modifiable.

This patent application is a national phase filing under section 371 of PCT/EP2016/062693, filed Jun. 3, 2016, which claims the priority of German patent application 10 2015110 242.0, filed Jun. 25, 2015, each of which is incorporated herein by reference in its entirety.

### TECHNICAL FIELD

A lamp is provided.

### BACKGROUND

If area light sources such as, for example, organic light-emitting diodes (OLEDs) need to be incorporated together with point light sources such as, for example, inorganic light-emitting diodes (LEDs) in a headlamp housing, space problems can arise, in particular if complex reflector designs are required in order to generate a suitable radiation field for the LEDs.

### SUMMARY OF THE INVENTION

Embodiments of the invention provide a lamp with two light sources.

According to at least one embodiment, a lamp comprises a first light source and a second light source. In particular, the first light source and the second light source are arranged spaced from one another in the lamp.

According to one further embodiment, the first light source is a point light-type light source. The term “point light-type light source” is hereinafter used to denote a light source which approximates to an ideal point light source and which has a small spatial extent relative to its distance from an object to be illuminated. In a point light source, the light propagates in the manner of a star in all directions or in at least one defined solid angle range. In particular, the first light source can comprise or consist of an inorganic light-emitting diode, an incandescent lamp, a gas discharge lamp or a plurality or combination of these. For example, the first light source can comprise one or more light-emitting diodes in the form of light-emitting diode chips which are arranged on a carrier or in a package. Light-emitting diode chips conventionally comprise an active area of less than a few square millimeters and thus emit light approximately from a point over a defined solid angle. Furthermore, the first light source can, for example, also comprise or consist of a conventional incandescent bulb, a tungsten-halogen lamp, a metal-halide lamp and/or a xenon gas discharge lamp, which can likewise be considered approximately as point light sources.

According to one further embodiment, the second light source takes the form of a light-emitting reflector. This means in particular that the second light source can on the one hand emit light itself and on the other hand serve as a reflector for the first light source, such that a desired radiation field can be generated from the light emitted by the first light source with the assistance of the light-emitting reflector.

The second light source is in particular embodied as an area light source. The term “area light source” is used here and hereinafter to denote a light source which is substantially planar in shape. The planar shape can be plate-like and thus flat or preferably also curved in one or more spatial directions. In particular, the second light source embodied as an area light source comprises two opposing major surfaces, one of which is embodied as a light-emitting face and whose dimensions are greater, preferably by at least one or more orders of magnitude, than a thickness of the area light source measured perpendicular to the major surfaces. In other words, the area light source comprises at least one light-emitting face embodied as a luminous face, the dimensions of which are greater than a thickness measured perpendicular to the light outcoupling face.

In particular, the second light source embodied as an area light source can have a large-area configuration in respect of the light-emitting face and thus in respect of the major surfaces. “Large-area” can here mean that the major surfaces and thus also the light-emitting face are embodied with an area of greater than or equal to a few square millimeters, preferably greater than or equal to one square centimeter and particularly preferably greater than or equal to one square decimeter. In particular, the second light source can take the form of a curved area light source, which partly surrounds the first light source. The second light source can in particular be shaped like conventional reflectors.

According to one further embodiment, the first light source is arranged spaced from the second light source embodied as a light-emitting reflector. This makes it possible for light to be emitted during operation of the first light source over preferably the entire light-emitting reflector or over at least one part thereof and thereby to be reflected by the light-emitting reflector in a desired direction with a desired emission pattern.

According to one further embodiment, the light-reflecting reflector is at least partly flexible and thus deformable. This means, in other words, that the second light source is at least partly flexible and thus deformable. With a deformable light-emitting reflector, it can be possible to modify and thus to adjust in a desired manner the emission pattern of the light emitted by the first light source and reflected by the light-emitting reflector.

According to one further embodiment, the second light source embodied as a light-emitting reflector comprises a reflective layer and an electroluminescent layer sequence. In particular, the electroluminescent layer sequence can comprise at least one light-emitting layer. The at least one light-emitting layer is arranged in particular on a side of the reflective layer facing the first light source. The side of the reflective layer facing the first light source is formed by a reflective surface which enables the reflective properties of the second light source. The electroluminescent layer sequence and the reflective layer are preferably of large-area configuration. Furthermore, the at least one light-emitting layer of the electroluminescent layer sequence can preferably extend over the entire reflective surface of the reflective layer. This can make it possible to generate light emission over the entire reflective surface of the reflective layer when the second light source is in operation. Alternatively, the at least one light-emitting layer of the electroluminescent layer sequence can also be arranged on just part of the reflective layer, such that the second light source can comprise light-emitting and reflective and just reflective regions.

According to one further embodiment, the electroluminescent layer sequence comprises an organic functional layer stack. The organic functional layer stack comprises at least one organic light-emitting layer in the form of an organic electroluminescent layer, which is designed to generate light when the second light source is in operation. The organic functional layer stack can also comprise a plurality of organic light-emitting layers and furthermore also further organic functional layers selected from charge carrier injection layers, charge carrier transport layers and charge carrier blocking layers. The electroluminescent layer sequence can take the form in particular of an organic light-emitting diode (OLED).

According to one further embodiment, the electroluminescent layer sequence comprises two electrodes, between which the organic functional layer stack is arranged. At least that electrode which is arranged on the side of the organic functional layer stack facing the first light source is transparent, such that the light generated by the second light source can be emitted. “Transparent” is used here and hereinafter to describe a layer which is transmissive to visible light. The transparent layer can here be clear or at least partly light-scattering and/or partly light-absorptive, such that the transparent layer can, for example, also be diffusely or milkily translucent. Particularly preferably, a layer here denoted as transparent exhibits the lowest possible light absorption and scattering.

The electrodes and the organic functional layer stack can in particular be of large-area configuration. In particular, the organic functional layer stack can preferably be formed in a large-area fashion over the reflective layer, such that the organic functional layer stack and here in particular the at least one organic light-emitting layer of the organic functional layer stack preferably covers the entire reflective surface of the reflective layer. Furthermore, it can also be possible for the organic functional layer stack and thus the at least one organic light-emitting layer to cover just part of the reflective surface of the reflective layer, such that part of the second light source is configured to be reflective and light-emitting and another part of the second light source is configured to be only reflective.

According to one further embodiment, the reflective layer forms one of the electrodes of the electroluminescent layer sequence. In other words, the electroluminescent layer sequence in this case comprises the reflective layer in the form of a reflective electrode to which the organic functional layer stack and thereover a transparent electrode are applied. Alternatively, it can also be possible for the electroluminescent layer sequence to comprise two transparent electrodes between which the organic functional layer stack is arranged. The electroluminescent layer sequence is then arranged with one of the transparent electrodes on the reflective layer.

According to one further embodiment, the reflective layer comprises a metal, which can be selected from aluminum, barium, indium, silver, gold, magnesium, calcium and lithium and compounds, combinations and alloys. In particular, the reflective layer can, for example, comprise Ag, Al or alloys therewith. If the reflective layer simultaneously forms an electrode of the electroluminescent layer sequence, Ag:Mg, Ag:Ca and Mg:Al in particular can, for example, be advantageous materials for the reflective layer.

According to one further embodiment, the second light source embodied as a light-emitting reflector is embodied as a collimator, such that the light from the first light source reflected by the reflective layer is collimated and can be emitted with minimal or no divergence by the lamp. In this case, the reflective surface of the reflective layer can comprise a focal point, wherein the first light source is arranged in the focal point of the reflective surface. Alternatively, the second light source embodied as a light-emitting reflector can also be non-collimating, such that the lamp is embodied as a divergent lighting device in relation to the light of the first light source.

The reflective surface of the reflective layer can, for example, be embodied at least in part as an elliptical paraboloid or as a rotational paraboloid. Furthermore, the reflective surface of the reflective layer can also be embodied as part of an ellipsoid, as part of a sphere or as a freeform surface. If the second light source is deformable, the shape of the reflective surface of the reflective layer can be modified, such that different emission patterns are possible in relation to the light of the first light source.

According to one further embodiment, the lamp is at least part of a motor vehicle headlamp, a torch or a head torch. The first and second light sources can here fulfill different functions. In the case of a motor vehicle headlamp, for example, the first light source can be used together with the reflective layer of the light-emitting reflector as a low-beam or high-beam headlight, while the light of the second light source is used as a daytime running light.

In the case of the lamp described here, the second light source, which takes the form of a light-emitting reflector, can be used both as a light source and also at the same time as a reflector for the first light source. In this way, an additional reflector for the first light source is dispensed with and more space can be available for positioning the light sources. It can moreover be possible to make the lamp smaller or to increase the density of luminous elements. By using a flexible second light source, it is additionally possible to adapt the emission pattern of the lamp, in particular in relation to the light of the first light source, since deformation of the light-emitting reflector embodied as a second light source leads to modification of the light path. Using the first light source and the second light source embodied as a light-emitting reflector can result in increased freedom of design, also and indeed specifically as a result of use of a deformable second light source. It has been found that, compared with the around 93% reflectivity of an aluminum reflector without light emission function conventionally used in headlamps, with the second light source described here and embodied as a light-emitting reflector a reflectivity of about 85% can still be achieved despite the additional layers.

### BRIEF DESCRIPTION OF THE DRAWINGS

Further advantages, advantageous embodiments and further developments are revealed by the exemplary embodiments described below in connection with the figures, in which:

FIG. 1 shows a schematic representation of a lamp with a first and a second light source according to one exemplary embodiment,

FIGS. 2 and 3 show schematic representations of second light sources for lamps according to further exemplary embodiments,

FIG. 4 shows a schematic representation of a lamp according to a further exemplary embodiment,

FIGS. 5A and 5B show schematic representations of a lamp according to a further exemplary embodiment, and

FIGS. 6A to 6B show schematic representations of a lamp according to a further exemplary embodiment.

In the exemplary embodiments and figures, identical, similar or identically acting elements are provided in each case with the same reference numerals. The elements illustrated and their size ratios to one another should not be regarded as being to scale, but rather individual elements, such as, for example, layers, components, devices and regions, can have been made exaggeratedly large to illustrate them better and/or to aid comprehension.

### DETAILED DESCRIPTION OF ILLUSTRATIVE EMBODIMENTS

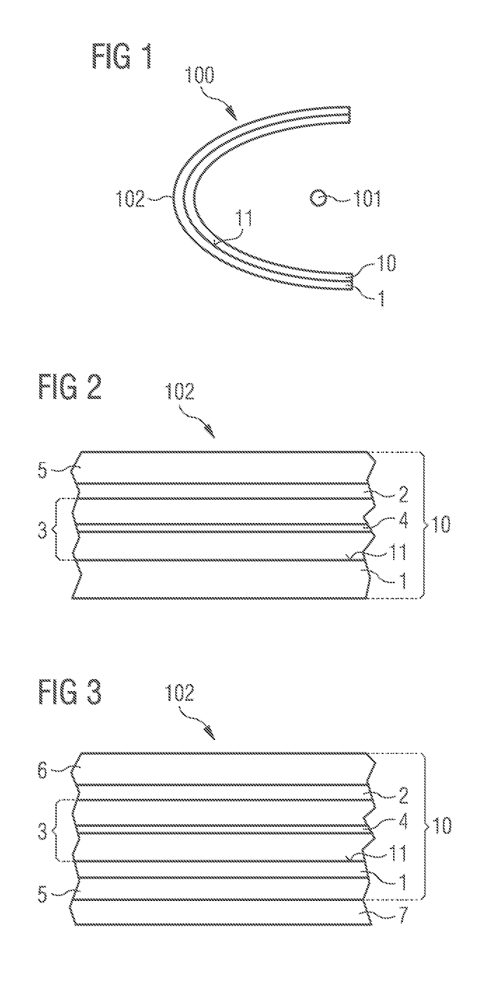

FIG. 1 shows an exemplary embodiment of a lamp 100 which comprises a first light source 101 and a second light source 102 spaced therefrom. The lamp 100 can, for example, be at least part of a motor vehicle headlamp, a torch or a head torch. Depending on the function and application of the lamp 100, the first and second light sources 101, 102 can emit the same or different light.

The first light source 101 is a point light-type light source, which comprises or consists of an inorganic light-emitting diode, an incandescent lamp, a gas discharge lamp or a plurality or combination of these. For example, the first light source 101 can comprise one or more light-emitting diodes in the form of light-emitting diode chips which are arranged on a carrier or in a package. Furthermore, the first light source 101 can, for example, also comprise or consist of a conventional incandescent bulb, a tungsten-halogen lamp, a metal-halide lamp and/or a xenon gas discharge lamp.

The second light source 102 is embodied as a light-emitting reflector. In this way, the second light source 102 can serve on the one hand as a reflector for the light emitted by the first light source 101 and, on the other hand, the second light source 102 can be used as an area light source separate from the first light source 101. To this end, the second light source 102 comprises a reflective layer 1 with a reflective surface 11 facing the first light source 101 for its reflection properties and an electroluminescent layer sequence 10 for its light emission properties. Detailed configurations of the second light source 102 are described in relation to FIGS. 2 and 3.

Depending on the application of the lamp 100, for example, as a motor vehicle headlamp, a torch or a head torch, the second light source 102 embodied as a light-emitting reflector can be embodied as a collimator or be only partly collimating or indeed non-collimating in relation to the first light source 101. If the second light source 102 is embodied as a collimating light-emitting reflector, the first light source 101 can be located in a focal point of the light-emitting reflector.

For example, the second light source 102 embodied as a light-emitting reflector and thus in particular the reflective surface 11 of the reflective layer 1 can be embodied at least in part as an elliptical paraboloid, at least in part as a rotational paraboloid, at least in part as part of an ellipsoid or a sphere or indeed as a freeform surface.

The second light source 102 can be rigid or deformable. If the second light source 102 and thus in particular the reflective layer 1 is deformable, the shape of the reflective surface 11 of the reflective layer 1 can be modified, such that the light path can be modified in relation to the light of the first light source 101, so making different emission patterns possible. In the case of a motor vehicle headlamp, an adaptive front-lighting system or a fog light can be achieved thereby, for example.

FIG. 2 shows an exemplary embodiment of a second light source 102 comprising a reflective layer 1 with a reflective surface 11 and an electroluminescent layer sequence 10. In the exemplary embodiment shown, the reflective layer 1 is embodied as part of the electroluminescent layer sequence 10.

In the exemplary embodiment shown, the electroluminescent layer sequence 10 comprises an organic functional layer stack 3 on the reflective surface 11 of reflective layer 1, said stack having at least one organic light-emitting layer 4 arranged between the reflective layer 1 as first electrode and a transparent further electrode 2. The reflective layer 1 can serve as a carrier layer and thus as a substrate for the further layers applied thereto. Alternatively, it can also be possible for the reflective layer 1 to be applied in the form of a coating to an additional substrate, not shown here, which can, for example, comprise one or more of the following materials: glass, plastics, metal, semiconductor material, ceramics.

The electroluminescent layer sequence 10 and thus the second light source 102 embodied as a light-emitting reflector is embodied in particular as an organic light-emitting diode (OLED) which, when in operation, emits light through the transparent electrode 2 in the direction of the first light source and in particular into the surrounding environment. The organic functional layer stack 3 can comprise layers with organic polymers, organic oligomers, organic monomers, organic small, non-polymeric molecules (“small molecules”) or combinations thereof. Materials suitable for the organic light-emitting layer 4 are materials which have radiation emission based on fluorescence or phosphorescence, for example, polyfluorene, polythiophene or polyphenylene, or derivatives, compounds, mixtures or copolymers thereof. The organic functional layer stack 3 can comprise, in addition to the at least one organic light-emitting layer 4, charge carrier transport layers and/or charge carrier blocking layers such as for instance hole transport layers, electrode transport layers, hole blocking layers, electron blocking layers and further organic functional layers.

The reflective layer 1 embodied as an electrode of the electroluminescent layer sequence 10 comprises a metal, which can be selected from aluminum, barium, indium, silver, gold, magnesium, calcium and lithium as well as compounds, combinations and alloys. In particular, the reflective layer 1 can comprise Ag, Al or alloys therewith, for example, Ag:Mg, Ag:Ca, Mg:Al.

The transparent electrode 2 can, for example, comprise a transparent conductive oxide (TCO). TCOs are transparent conductive materials, generally metal oxides such as, for example, zinc oxide, tin oxide, cadmium oxide, titanium oxide, indium oxide, indium tin oxide (ITO) or aluminum zinc oxide (AZO). In addition to binary metal-oxygen compounds, such as, for example, ZnO, SnO₂ or In₂O₃, ternary metal-oxygen compounds, such as, for example, Zn₂SnO₄, CdSnO₃, ZnSnO₃, MgIn₂O₄, GaInO₃, Zn₂In₂O₅ or In₄Sn₃O₁₂ or mixtures of different transparent conductive oxides also belong to the TCO group. Furthermore, TCOs do not necessarily correspond to a stoichiometric composition and can also be p- or n-doped. Furthermore, the transparent electrode 2 can comprise a metal layer with a metal or an alloy, for example, with one or more of the following materials: Ag, Pt, Au, Mg, Ag:Mg. The metal layer in this case exhibits a thickness which is small enough to be at least partly transmissive to light, for example, a thickness of less than or equal to 50 nm or less than or equal to 20 nm. Furthermore, the transparent electrode 2 can comprise or consist of silver nano wires (SNW). Furthermore, the transparent electrode 2 can also comprise or consist of a metal grid combined with a highly conductive hole injection layer or a conductive polymer. The transparent electrode 2 can also comprise or consist of a combination of layers with the stated materials.

In the exemplary embodiment shown, when viewed from the reflective layer 1 an encapsulation 5 is further applied over the organic functional layer stack 3 and the electrode 2 which is suitable for forming a barrier relative to atmospheric substances, in particular relative to moisture and oxygen and/or relative to further harmful substances such as for instance corrosive gases, for example, hydrogen sulfide. Particularly preferably, the encapsulation 5 can take the form of thin-film encapsulation. The encapsulation 5 can to this end comprise one or more layers each with a thickness of less than or equal to a few 100 nm. In particular, the thin-film encapsulation can comprise or consist of thin layers which are applied, for example, by means of an atomic layer deposition (ALD) method. Suitable materials for the layers of the encapsulation 5 are, for example, aluminum oxide, zinc oxide, zirconium oxide, titanium oxide, hafnium oxide, lanthanum oxide or tantalum oxide. The encapsulation 5 can, for example, comprise a layer sequence with a plurality of the thin layers which each comprise a thickness of between one atomic layer and 10 nm, limit values included. As an alternative or in addition to thin layers produced by ALD, the encapsulation 5 can comprise at least one or a plurality of further layers, i.e., in particular barrier layers and/or passivation layers, which are deposited by thermal vapor deposition or by a plasma-enhanced process, for instance sputtering or plasma-enhanced chemical vapor deposition (PECVD). Suitable materials for this purpose can be the above-stated materials together with silicon nitride, silicon oxide, silicon oxynitride, indium tin oxide, indium zinc oxide, aluminum-doped zinc oxide, aluminum oxide and mixtures and alloys of the stated materials. The one or more further layers can, for example, each have a thickness of between 1 nm and 5 μm and preferably between 1 nm and 400 nm, limit values included.

By selecting suitable materials, in particular with regard to the reflective layer 1 and optionally an additional substrate, the second light source 102 can be rigid or indeed flexible and thus deformable. The reflective layer 1 can thus, for example, be formed by a flexible metal foil, which serves at the same time as a substrate for the further layers. Furthermore, it is also conceivable for the reflective layer 1 to be applied in the form of a metal layer to a substrate in the form of a plastics film or an at least partly deformable glass film.

FIG. 3 shows a further exemplary embodiment of a second light source 102 which, compared with the previous exemplary embodiment, comprises an electroluminescent layer sequence 10 with a transparent substrate 6 to which are applied the transparent electrode 2, the organic functional layer stack 3, the reflective layer 1 as further electrode and the encapsulation 5.

The electroluminescent layer sequence 10 can be manufactured separately as a flexible layer sequence and is applied to a carrier 7 by the encapsulation side. The carrier 7, which can, for example, comprise a plastics material and/or a metal, can in this case form the basic shape of the light-emitting reflector, which is coated with the electroluminescent layer sequence 10 and thus in particular also with the reflective layer 1.

Alternatively, it can also be possible for the reflective layer of the second light source 102 to be formed by the carrier 7. In this case, the electroluminescent layer sequence 10 comprises a transparent electrode between the organic functional layer stack 3 and the encapsulation 5.

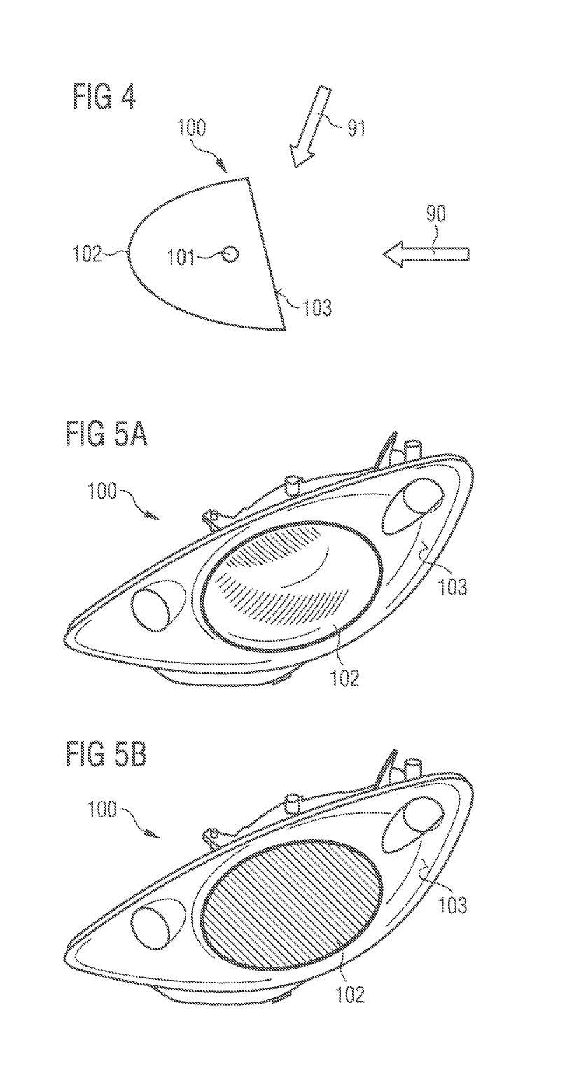

FIG. 4 shows a further exemplary embodiment of a lamp 100 which can be configured according to the previous exemplary embodiments. In comparison with the exemplary embodiment of FIG. 1, the lamp 100 of the exemplary embodiment of FIG. 4 additionally comprises an exit face 103, via which the light generated respectively by the first light source 101 and the second light source 102 when in operation is emitted. The exit face 103 can, for example, be formed by a glass window.

While the emission pattern of the light generated by the first light source 101 is determined and, for example, directed by the shape of the second light source 102 embodied as a light-emitting reflector, the emission pattern of the light generated by the second light source 102 corresponds substantially to a Lambertian emission pattern at the exit face 103. In this way, the brightness of the exit face 103 when the second light source 102 is in operation is perceived as the same from all directions of view onto the exit face 103, two of which directions of view 90, 91 are shown by way of example in FIG. 4, since the luminance remains constant. Only the visible luminous area changes.

In this way, the lamp 100 can, for example, be suitable as a motor vehicle headlamp, in which the first light source 101 can, for example, have the function of a low-beam and/or high-beam headlamp, while the second light source 102 is ideal for providing a daytime running light.

FIGS. 5A and 5B show a lamp 100 embodied accordingly as a motor vehicle headlamp, with the view directed onto the exit face 103 formed by a headlamp glass. The position of the second light source 102 is indicated by the correspondingly labeled region, while the first light source, which is located inside the lamp 100, is not shown for clarity's sake.

FIG. 5A shows the lamp 100 with its second light source 102 switched off, the second light source 102 merely adopting the function of a reflector for the first light source. In FIG. 5B, on the other hand, the lamp 100 is indicated with its second light source 102 switched on and thus with a luminous reflector, forming a daytime running light which merges with the design of the headlamp.

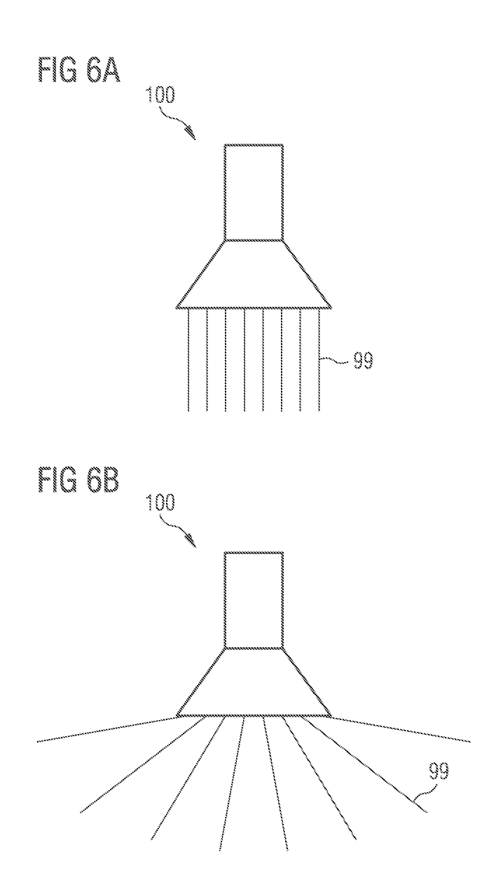

FIGS. 6A and 6B show a lamp 100 according to a further exemplary embodiment, which can, for example, take the form of a torch or head torch. FIG. 6A shows an operating state of the lamp 100 in which the first light source is being operated. The corresponding emission pattern is indicated by means of the beams of light 99. When the first light source is in operation, a high-beam function is thus enabled, for example, for illuminating a remote object. The light of the first light source is directed into the distance via the reflective layer of the second light source and can exit the lamp 100 in parallel or with slight widening.

FIG. 6B shows an operating state of the lamp 100 in which the second light source is being operated. The corresponding emission pattern is again indicated by means of the beams of light 99. Operation of the second light source allows diffuse and uniform illumination of the surrounding environment, such that the lamp 100 can be used in this operating state, for example, as a reading light or as a safety light for near-field illumination, allowing better visibility.

In a further operating state, both light sources can also be operated simultaneously, such that the emission patterns indicated in FIGS. 6A and 6B are superimposed. In this way, a strong beam of light produced by the first light source is able to provide distance illumination, while the second light source provides close range lighting.

The exemplary embodiments described in the figures can additionally or alternatively comprise further features according to the embodiments described above in the general part of the description.

The description made with reference to exemplary embodiments does not restrict the invention to these embodiments. Rather, the invention encompasses any novel feature and any combination of features, including in particular any combination of features in the claims, even if this feature or this combination is not itself explicitly indicated in the claims or exemplary embodiments.

1-10. (canceled)

11. A lamp comprising:
a first light source; and
a second light source embodied as a light-emitting reflector with a reflective layer and an electroluminescent layer sequence, wherein the second light source is deformable such that an emission pattern of light emitted by the first light source and reflected by the light-emitting reflector is modifiable.

12. The lamp according to claim 11, wherein the electroluminescent layer sequence comprises an organic functional layer stack with at least one organic light-emitting layer.

13. The lamp according to claim 12, wherein the organic functional layer stack is arranged between two electrodes.

14. The lamp according to claim 13, wherein the reflective layer comprises one of the electrodes.

15. The lamp according to claim 12, wherein the organic functional layer stack is formed in a large-area fashion over the reflective layer.

16. The lamp according to claim 11, wherein the electroluminescent layer sequence comprises an organic light-emitting diode.

17. The lamp according to claim 11, wherein the first light source is spaced apart from the second light source.

18. The lamp according to claim 11, wherein the first light source is a point light-type light source.

19. The lamp according to claim 18, wherein the first light source comprises an inorganic light-emitting diode.

20. The lamp according to claim 18, wherein the first light source comprises an incandescent lamp.

21. The lamp according to claim 18, wherein the first light source comprises a gas discharge lamp.

22. The lamp according to claim 11, wherein the lamp is part of a motor vehicle headlight.

23. The lamp according to claim 11, wherein the lamp is part of a flashlight.

24. The lamp according to claim 11, wherein the lamp is part of a head torch or headlamp.
